(19) United States
(12) Patent Application Publication
(10) Pub. No.: US 2007/0063111 A1
(43) Pub. Date: Mar. 22, 2007

(54) Flat flexible cable retainer with undulated surface

(76) Inventors: Michael J. Alloway, Canton, MI (US); Charles Heard, Detroit, MI (US); Gary Vettese, Sterling Heights, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/230,429

(22) Filed: Sep. 20, 2005

(51) Int. Cl. F16B 15/00

(52) U.S. Cl. 248/71

(57) ABSTRACT

A retainer for a flat flexible cable includes a first closure portion having a top surface, a bottom surface and side surfaces, a second closure portion having a top surface, a bottom surface and side surfaces, and a hinge portion separating the first and second closure portions. At least one of the top surfaces has an undulated profile for frictionally engaging and positively securing a cable at a desired location when the retainer is placed in a closed position.

### TECHNICAL FIELD

The present invention generally relates to a clip or retainer for a flat flexible cable, and in particular to a retainer that can be positioned at a desired location along the cable and having an undulated surface for frictional engaging and positively securing the clip or retainer to the cable at a desired location when the retainer has been placed in a locked position.

### BACKGROUND OF THE INVENTION

Conventional methods for attaching wire harnesses to a vehicle body require a troublesome process for binding a wire harness retainer to the wire harness. Typically, the wire harness and the wire harness retainer are bound together by adhesives, tapes or the like. As a result, the location of the retainer is not adjustable along the wire harness. Consequently, the wire harness and the wire harness retainer may not be properly aligned with the corresponding apertures in the vehicle body. The result is that the wire harness and the wire harness retainer may not be properly mounted to the vehicle body, or in some extreme cases, the wire harness and wire harness retainer may not be able to be mounted at all to the vehicle body.

### SUMMARY OF THE INVENTION

The inventors of the present invention have recognized these and other problems associated with the wire harness retainers. To this end, the inventors have invented a retainer for a flat, flexible cable comprising a first closure portion having a top surface, a bottom surface and side surfaces, a second closure portion having a top surface, a bottom surface and side surfaces, and a hinge portion separating the first and second closure portions. At least one of the top surfaces has an undulated profile for frictionally engaging and positively securing a cable at a desired location when the retainer is placed in a closed position.

### BRIEF DESCRIPTION OF THE DRAWINGS

FIG. 1 is a perspective view of a retainer for receiving a flat flexible cable according to an embodiment of the invention when in a open position.

FIG. 2 is a top view of the retainer when in the open position according to an embodiment of the invention.

FIG. 3 is a partial cross-sectional view of the retainer when in the open position according to an embodiment of the invention taken along line 3-3 of FIG. 2.

FIG. 4 is a partial cross-sectional view of the retainer when in the open position according to an embodiment of the invention taken along line 4-4 of FIG. 2.

FIG. 5 is an end view of the retainer when in the open position according to an embodiment of the invention.

FIG. 6 is a perspective view of a retainer for receiving a flat flexible cable according to an embodiment of the invention when in a closed position.

FIG. 7 is a cross-sectional view of the retainer when in the closed position according to an embodiment of the invention taken along line 7-7 of FIG. 6.

### DETAILED DESCRIPTION

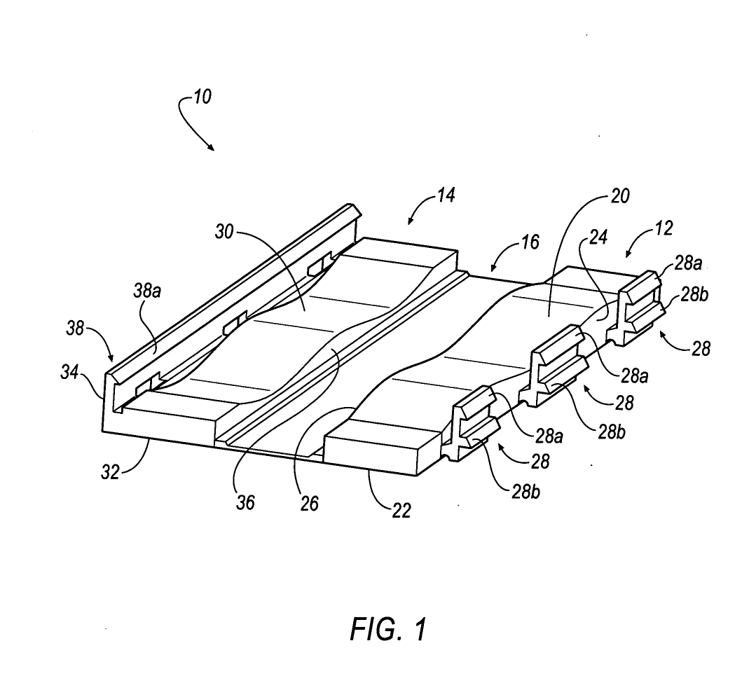

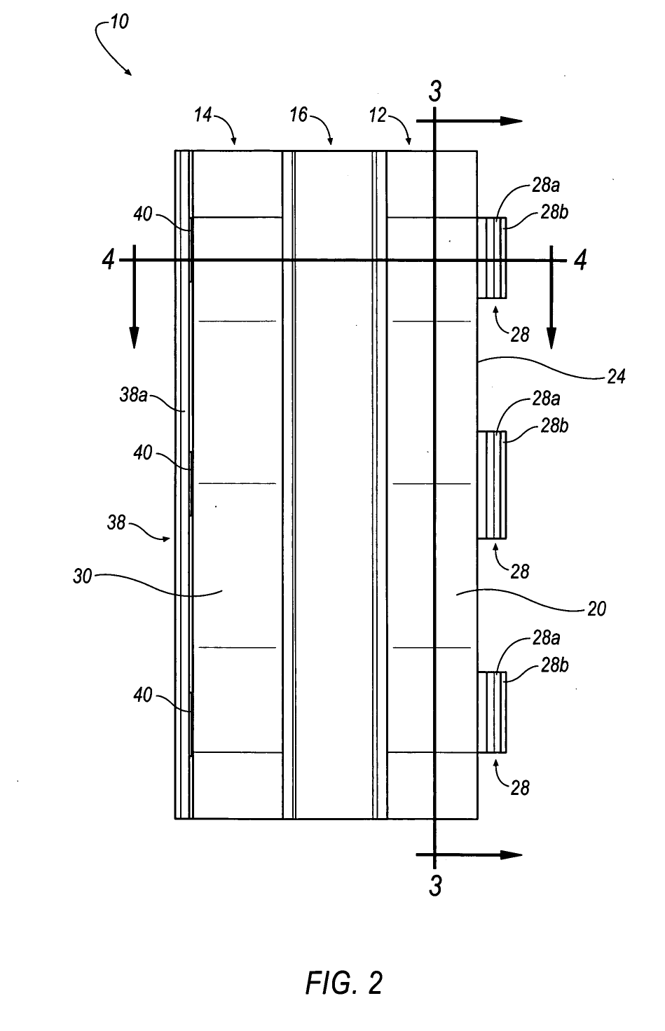

Referring to FIGS. 1-5, a clip or retainer for a flat flexible cable is generally shown at 10. In general, the retainer 10 comprises a first closure portion 12 and a second closure 14 portion connected by a hinge portion 16. The hinge portion 16 may have a smaller thickness than the first and second closure portions 12, 14, thereby forming a living hinge, or the like, for allowing the first and second closure portions 12, 14 to hinge relative to one another. In the illustrated embodiment, the first closure portion 12, the second closure 14 and the hinge portion 16 are integrally formed as a single piece. The retainer 10 may be formed from any number of materials, such as, for example, polyvinyl chloride, polypropylene, or the like.

As illustrated, the retainer 10 also includes a retaining member 18 similar to a conventional “Christmas tree” retainer as is known in the art. The retaining member 18 comprises a plurality of truncated flat surfaces 18a generally forming the shape of a cone. It will be apparent to those skilled in the art that the retaining member 18 may be substituted with any other type of mounting clip, stud and other known equivalents can be used. For example, the retaining member 18 may comprise an adhesive, tape, or the like. In the illustrated embodiment, the retaining member 18 is centrally located on the second closure portion 14. However, it will be appreciated that the retaining member 18 can be located at any desired location on the retainer 10, such as, for example, on the first closure portion 12.

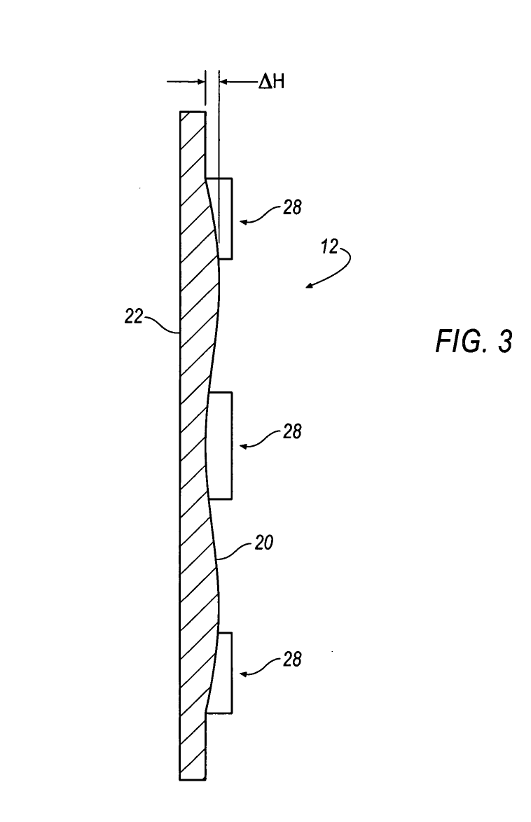

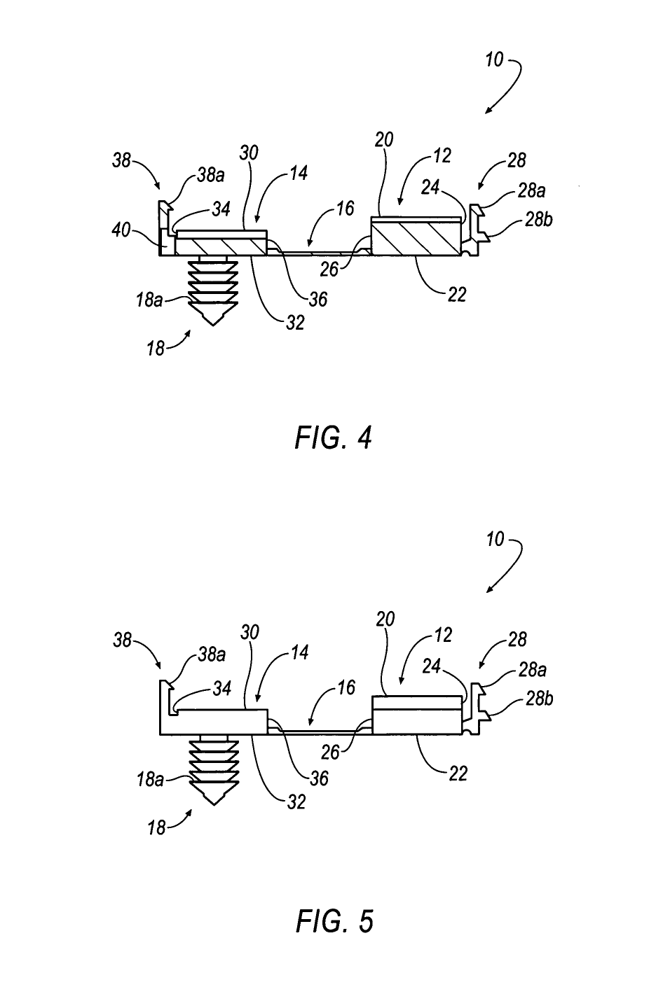

The first closure portion 12 includes a top surface 20, a bottom surface 22 and side surfaces 24, 26. The top surface 20 comprises an undulated surface in the form a sinusoidal or S-shaped profile, as seen in FIGS. 1 and 3. The undulated top surface 20 is defined by a series of peaks and valleys having a difference, ΔH, in height in the range of about 0.5 to about 4.0 mm. For example, the difference in height, ΔH, between the peaks and valleys can be about 2.0 mm. Unlike the top surface 20, the bottom surface 22 may be substantially planar surface. However, the invention is not limited by the profile of the bottom surface 22. The side surface 24 includes one or more substantially identical attachment portions, shown generally at 28, extending outwardly from the side surface 24, as shown in FIGS. 4 and 5. Each attachment portion 28 includes one or more outwardly extending tabs 28a, 28b. If desired, the tab 28b may extend outward further from the side surface 24 than the tab 28a. The purpose of the tabs 28a, 28b will be described in more detail below.

The second closure portion 14 includes a top surface 30, a bottom surface 32 and side surfaces 34, 36. Similar to the top surface 20, the top surface 30 comprises an undulated surface in the form a sinusoidal or S-shaped profile, as seen in FIG. 1. The undulated top surface 30 is defined by a series of peaks and valleys having a difference, ΔH, in height in the range of about 0.5 to about 4.0 mm. For example, the difference in height, ΔH, between the peaks and valleys can be about 2.0 mm, similar to the undulated top surface 20. As shown in FIG. 1, the peak of the top surface 30 of the second closure portion 14 may correspond to a valley of the top surface 20 of the first closure portion 12. Conversely, the valley of the top surface 30 of the second closure portion 14 may coincide with a corresponding peak of the top surface 20 of the first closure portion 12 such that the top surfaces 20, 30 mate with each other.

The bottom surface 32 may have a substantially planar surface. However, the invention is not limited by the profile of the bottom surface 32. The side surface 34 includes at least one attachment portion, shown generally at 38, extending outwardly from the side surface 34 and along the entire length of the retainer 10, as shown in FIGS. 4 and 5. However, it will be appreciated that the attachment portion 38 may be provided on the side surface 34 in a one-to-one correspondence with the attachment portions 28 of the first closure portion 12. For example, there may be three attachment portions 28 and three corresponding attachment portions 38, rather than a single attachment portion 38 running the entire length of the side surface 34. The attachment portion 38 includes a tab 38a for engaging the tabs 28a, 28b of the attachment portion 28 such that the first and second closure portions 12, 14 are capable of interlocking with one another by hinging the retainer 10 about the hinge portion 16 and snapping the attachment portion 38 into the attachment portions 28. As seen in FIG. 4, the second closure portion 14 may include one or more thru-slots 40 for allowing insertion of a tool, such as a screwdriver, or the like, to unsnap the first and second closure portions 12, 14, if desired.

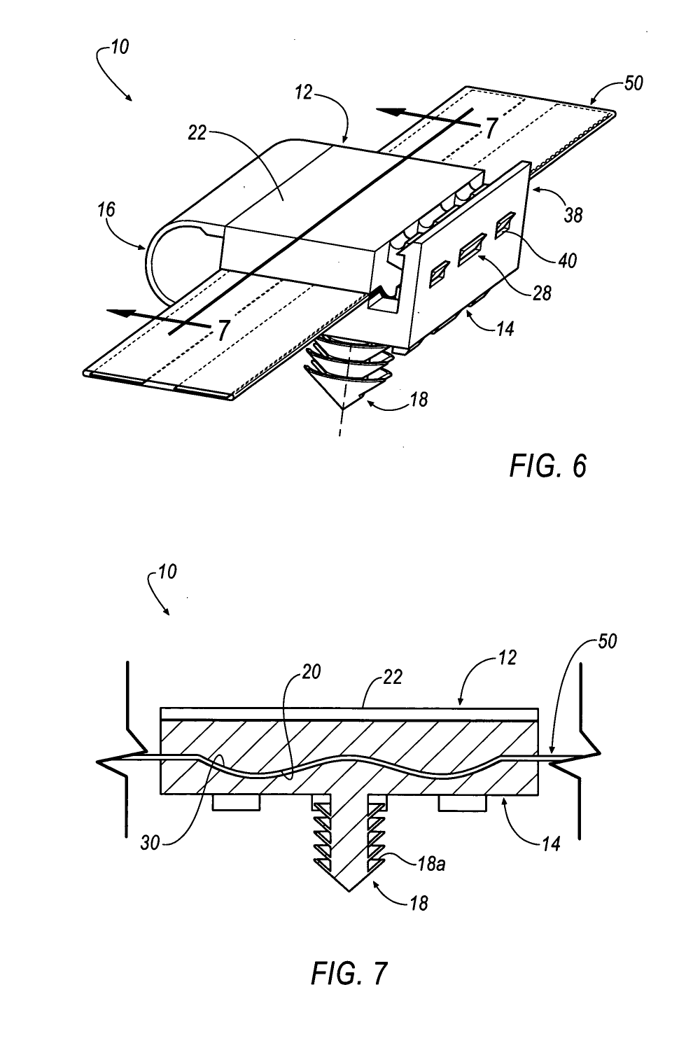

In operation, a flat flexible cable 50 is placed on one of the first and second closure portions 12, 14 when the retainer 10 is in an open position such that the retainer 10 is placed at a desired location on the cable 50. Then the first and second closure portions 12, 14 are hinged about the hinge portion 16 until the attachment portions 28, 38 snap together in an interlocking relationship to place the retainer 10 in a closed position, as shown in FIGS. 5 and 6. When the retainer 10 is in the closed position, the first and second closure portions 12, 14 frictionally engage the cable 50 and prevent the cable 50 from moving relative to the retainer 10. It will be appreciated that the first and second portions 12, 14 of the retainer 10 have a sufficient width to allow the cable 50 to be placed on one of the first and second portions 12, 14 and hinged about the hinge portion 16 without interference by the cable 50.

The embodiments disclosed herein have been discussed for the purpose of familiarizing the reader with novel aspects of the invention. Although preferred embodiments of the invention have been shown and described, many changes, modifications and substitutions may be made by one having ordinary skill in the art without necessarily departing from the spirit and scope of the invention as described in the following claims.

1. A retainer for a flat, flexible cable, comprising:
a first closure portion having a top surface, a bottom surface and side surfaces;
a second closure portion having a top surface, a bottom surface and side surfaces; and
a hinge portion separating the first and second closure portions,
wherein at least one of said top surfaces has an undulated profile for frictionally engaging and positively securing a cable at a desired location when said retainer is placed in a closed position.

2. The retainer according to claim 1, further comprising a retaining member located on one of the first and second closure portions.

3. The retainer according to claim 1, wherein both top surfaces have an undulated profile.

4. The retainer according to claim 3, wherein a valley of the top surface of the second closure portion coincides with a corresponding peak of the top surface of the first closure portion such that the top surfaces mate with each other.

5. The retainer according to claim 3, wherein a valley of said top surface of the second closure portion does not coincide with a corresponding peak of said top surface of said first closure portion.

6. The retainer according to claim 3, wherein said undulated profile is sinusoidal in shape.

7. The retainer according to claim 3, wherein said undulated profile is defined by a series of peaks and valleys having a difference, ΔH, in height in a range of about 0.5 to about 4.0 mm.
